(19) United States
(12) Patent Application Publication
(10) Pub. No.: US 2015/0262308 A1
(43) Pub. Date: Sep. 17, 2015

(54) METHODS FOR IMPROVING CLAIMS PROCESSING FOR A VEHICLE IN AN EVENT AND DEVICES THEREOF

(71) Applicant: Wipro Limited, Bangalore (IN)

(72) Inventors: Ramachandra Budihal, Bangalore (IN); Ragupathy Jayaraj, Bangalore (IN); Ramprasad Kanakatte Ramanna, Bangalore (IN); Mukesh Manjunath Prabhu, Mangalore (IN)

(73) Assignee: Wipro Limited, Bangalore (IN)

(21) Appl. No.: 14/260,055

(22) Filed: Apr. 23, 2014

(30) Foreign Application Priority Data
Mar. 11, 2014 (IN) 1263/CHE/2014

(51) Int. Cl. G06Q 40/08; G06K 9/62

(52) U.S. Cl. CPC G06Q 40/08; G06K 9/6202; G06K 9/6215

(57) ABSTRACT

A method, device, and non-transitory computer readable medium that improves claims processing for a vehicle in an event includes receiving an application code and one or more images of the vehicle captured by a photographic device in a portable computing device based on received guidance. A claims application for a user is filled based on the application code and the one or more images. The claims application is authenticated and a claim amount is calculated based on the authenticated claims application. A determination is made whether the calculated claim amount is approved for the claims application based on a stored claim limit associated with the user. An indication on the determination of whether the calculated claim amount is approved is provided.

This application claims the benefit of Indian Patent Application No. 1263/CHE/2014 filed Mar. 11, 2014, which is hereby incorporated by reference in its entirety.

### FIELD

This disclosure generally relates to insurance claims processing, and more specifically to a methods for improving claims processing for a vehicle in an event and devices thereof.

### BACKGROUND

With an increasing number of vehicles and often an inadequate supporting traffic infrastructure coupled with prevalent negligent driving, vehicle accidents have increased multifold in the modern world. It is estimated that by about 2050 there will be about 3 billion cars in the world as compared to about 750 million cars today. In just the USA, there are approximately 18 million accidents every year. Post-accident, different industries benefit from about 55 billion USD out of which about 12-13 billion USD is for claims adjustment expenses, which are plagued with inefficient processes and systems.

In order to cover the costs incurred due to a vehicular accident, very frequently a requirement for insurance has been made a part of national policy the world over. Typically the insurance settlement takes place between the policy holder and the insurance provider or through a third party that specializes in mediation and negotiation between the two parties involved. Over time it is clearly understood that the people, process, time and effort required in handling insurance claim settlements is very high. As part of handling these settlement claims, some of the usual issues or problems that insurance companies come across are fraudulent claims or applications, time consuming and tedious claim validation (which would involve semi and full manual intervention by investigators) and settlement process, and insufficient numbers of skilled claim adjusters who are costly. Additionally, policy holders often are not in a clear mental state to provide all of the required information for a claim in an accident scenario. Further, with existing claims substantial processing time is required for completion of a manual inspection of the damage appropriate completion and submission of claim forms, and determination of an appropriate claims estimate. All of the above lead to multiple iterations, extensive time and effort in the process of claim settlement.

### SUMMARY

A method for improving claims processing for a vehicle in an event includes receiving, at a claims management data server device, an application code and one or more images of the vehicle captured by a photographic device in a portable computing device based on received guidance. A claims application for a user is filled by the claims management server device based on the application code and the one or more images. The claims application is authenticated by the claims management data server device. A claim amount is calculated by the claims management data server device based on authenticated claims application. A determination is made whether the calculated claim amount is approved for the claims application by the claims management data server device based on a stored claim limit associated with the user. An indication on the determination of whether the calculated claim amount is approved is provided by the claims management data server device.

A non-transitory computer readable medium having stored thereon instructions for improving claims processing for a vehicle in an event comprising machine executable code which when executed by a processor, causes the processor to perform steps including receiving an application code and one or more images of the vehicle captured by a photographic device in a portable computing device based on received guidance. A claims application for a user is filled based on the application code and the one or more images. The claims application is authenticated and a claim amount is calculated based on the authenticated claims application. A determination is made whether the calculated claim amount is approved for the claims application based on a stored claim limit associated with the user. An indication on the determination of whether the calculated claim amount is approved is provided.

A claims management data server device, comprising a memory and a processor coupled to the memory and configured to execute programmed instructions stored in the memory including receiving an application code and one or more images of the vehicle captured by a photographic device in a portable computing device based on received guidance. A claims application for a user is filled based on the application code and the one or more images. The claims application is authenticated and a claim amount is calculated based on the authenticated claims application. A determination is made whether the calculated claim amount is approved for the claims application based on a stored claim limit associated with the user. An indication on the determination of whether the calculated claim amount is approved is provided.

It is to be understood that both the foregoing general description and the following detailed description are exemplary and explanatory only and are not restrictive of the invention, as claimed.

### BRIEF DESCRIPTION OF DRAWINGS

FIG. 1 is diagram of an exemplary environment with a claims management data server device for facilitating claims processing; and

FIGS. 2a and 2b are flowcharts of an exemplary method for facilitating claims processing.

### DETAILED DESCRIPTION

Now, exemplary embodiments of the present disclosure will be described with reference to the accompanying drawings. Wherever possible, the same reference numbers will be used throughout the drawings to refer to the same or like parts. While exemplary embodiments and features are described herein, modifications, adaptations, and other implementations are possible, without departing from the spirit and scope of the disclosure. Accordingly, the following detailed description does not limit the subject matter. Instead, the proper scope of the subject matter is defined by the appended claims.

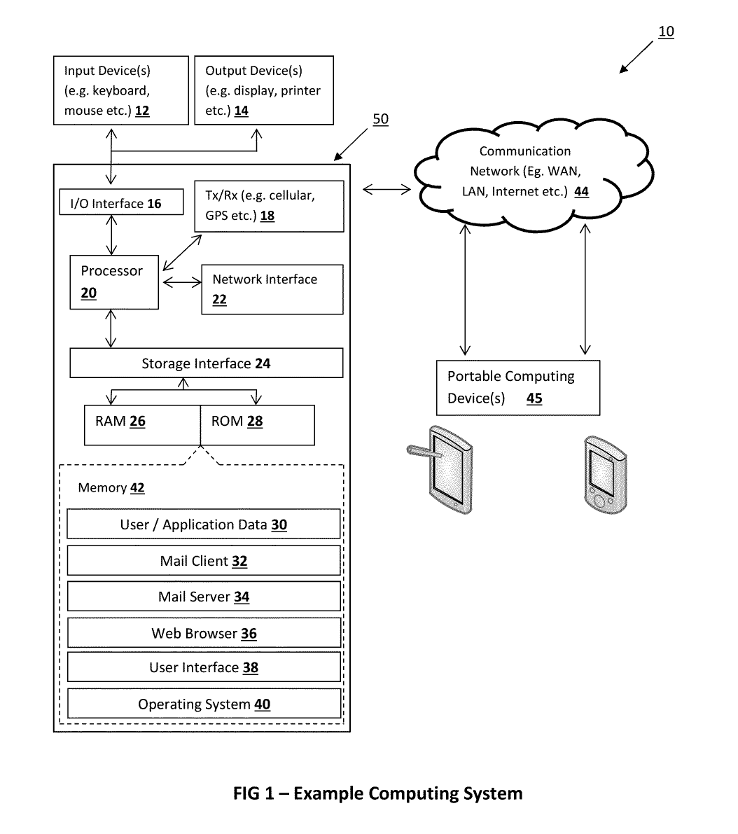

FIG. 1 illustrates an exemplary environment 10 includes a plurality of portable computing devices 45 and a claims management data server device 50 coupled together by a communications network 44, a plurality of input devices 12, and output devices 14, although the environment can include other types and numbers of systems, devices, components, and other elements in a variety of other topologies and deployments.

FIG. 1 illustrates a block diagram of the claims management data server device 50 for implementing embodiments consistent with the present disclosure, although other types and numbers of computing devices can be used in implementing the claims management data server device. Claims management data server device 50 may comprise a central processing unit (“CPU” or “processor”) 20. Processor 20 may comprise at least one data processor for executing program components for executing user- or system-generated requests. A user may include a person, a person using a device, such as such as those included in this disclosure or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 20 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 20 may be disposed in communication with one or more input/output (I/O) devices via I/O interface 16. The I/O interface 16 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 16, the claims management data server device 50 may communicate with one or more input device(s) 12 and output device(s) 14, although the I/O interface 16 may facilitate communications with other types and numbers of systems, devices, components, and other elements. The input device 12 may be an antenna, keyboard, mouse, joystick, (infrared) remote control, camera, charge-coupled device (CCD), card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 14 may be a printer, fax machine, video display (e.g., cathode ray tube (CRT), liquid crystal display (LCD), light-emitting diode (LED), plasma, or the like), audio speaker, etc. In some embodiments, a transceiver 18 may be disposed in connection with the processor 20. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 20 may be disposed in communication with a communication network 44 via a network interface 22. The network interface 22 may communicate with the communication network 44. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 44 may include, without limitation, a direct interconnection, local area network (LAN), wide area network (WAN), wireless network (e.g., using Wireless Application Protocol), the Internet, etc. Using the network interface 22 and the communication network 44, the claims management data server device 50 may communicate with portable computing devices 45, although the network interface 22 could be used to communicate with other types and numbers of other systems, devices, components and other elements. These other systems, devices, components and other elements may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the claims management data server device 50 may itself embody one or more of these devices.

In some embodiments, the processor 20 may be disposed in communication with one or more memory devices 42 (e.g., RAM 26, ROM 28, etc.) via a storage interface 24. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The one or more memory devices 42 may store a collection of programmed instructions or database components, including, without limitation, an operating system 40, user interface application 38, web browser 36, mail server 34, mail client 32, user/application data 30 (e.g., any data variables or data records discussed in this disclosure), etc. The operating system 40 may facilitate resource management and operation of the claims management data server device 50. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 38 may facilitate display, execution, interaction, manipulation, or operation of program components through textual or graphical facilities. For example, user interfaces may provide computer interaction interface elements on an output device 14 operatively connected to the claims management data server device 50, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the claims management data server device 50 may implement a web browser 36 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the claims management data server device 50 may implement a mail server 34 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the claims management data server device 50 may implement a mail client 32 stored program component. The mail client may be a mail viewing application, such as Apple Mail, Microsoft Entourage, Microsoft Outlook, Mozilla Thunderbird, etc.

In some embodiments, claims management data server device 50 may store user/application data 30, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

In some embodiments, claims management data server device 50 may store user insurance data which includes but is not restricted to vehicle registration number of the user. The claims management data server device 50 may then be used to compare the vehicle registration number recovered from the one or more required received images (using an Optical Character Reader) with the vehicle registration numbers present in its user insurance records and subsequently retrieve stored user insurance data to help fill up the standard claims application to the maximum extent possible.

In some embodiments, the claims management data server device 50 may store user insurance data which includes but is not restricted to a stored claim limit specific to the user. The stored claim limit specific to the user can be based on but not restricted to, a few parameters like user claim history, user insurance policy details, and total monetary value of claims and then may be compared to a calculated claims amount for possible approval of the calculated claims amount.

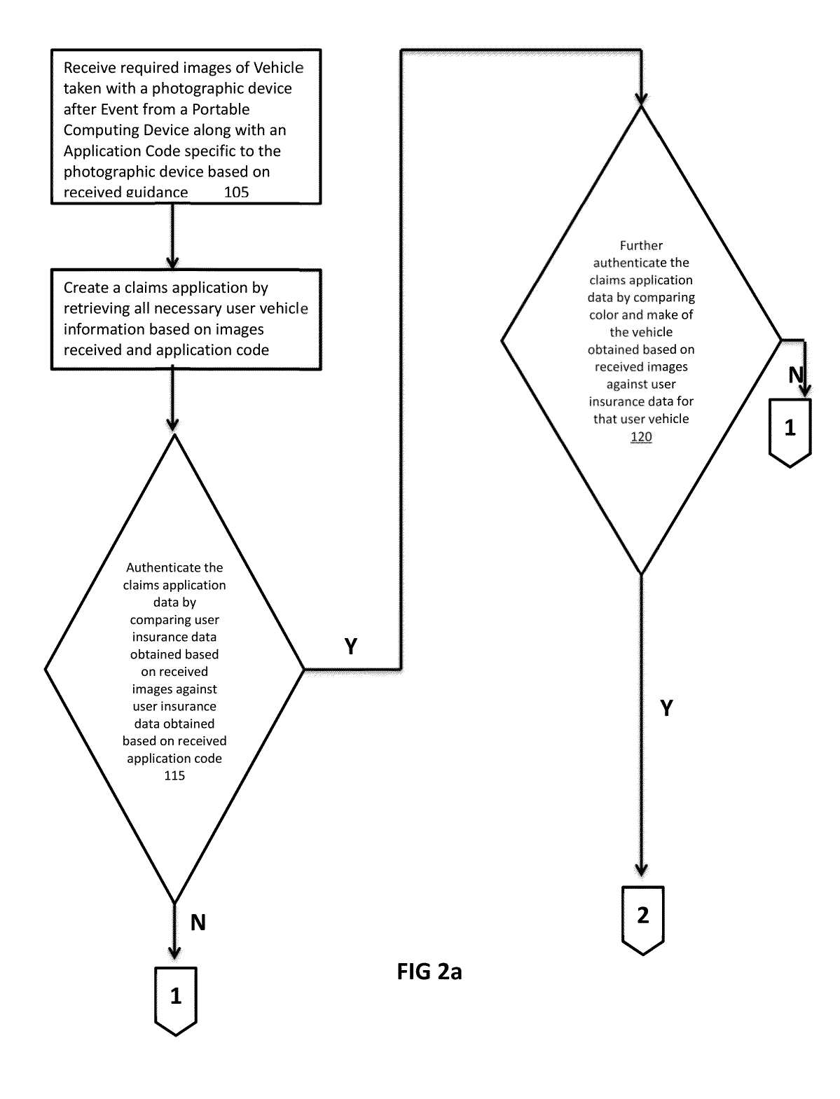

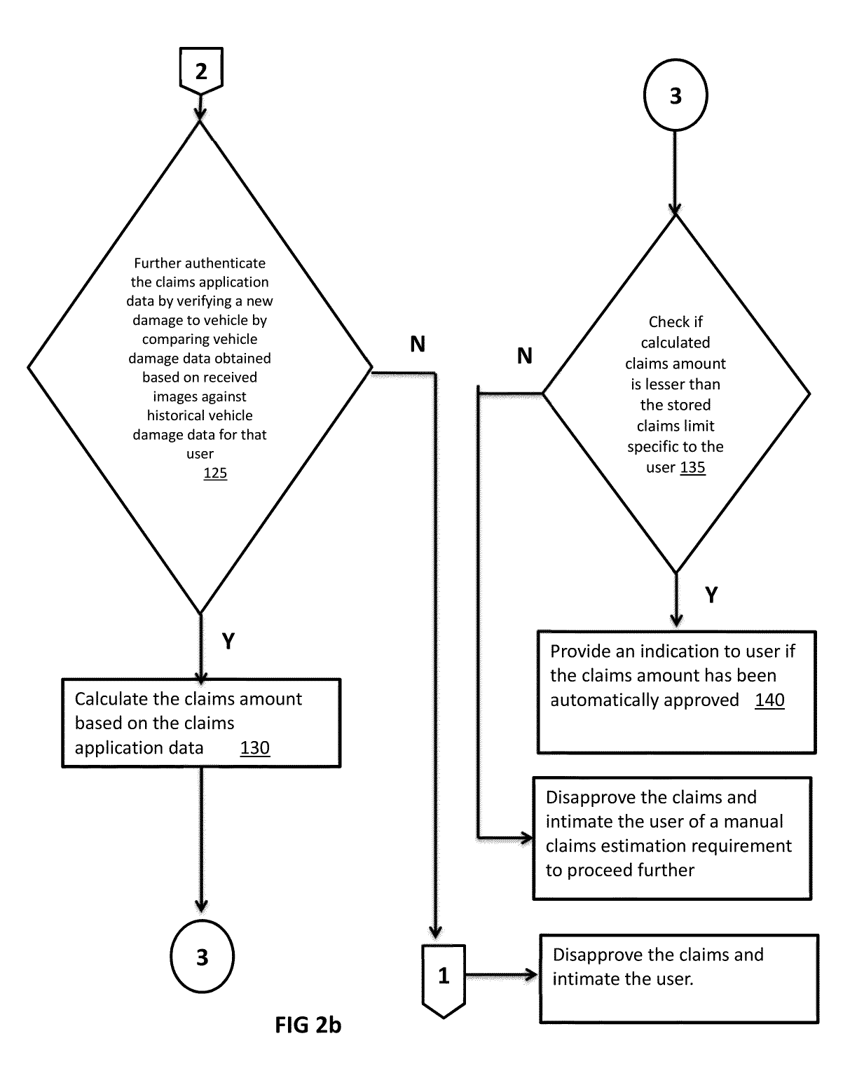

An exemplary method for improving claims processing for a vehicle in an event will now be described with reference to FIGS. 1-2b. The exemplary method begins at step 105 of FIG. 2a where the claims management data server device, which is an example of the claims management data server device 50 described in FIG. 1, receives various types of images taken of the vehicle after an event, where the event is typically described as a physical accident along with an application code. The various types of images are taken by a photographic device in a portable computing device 45 based on received guidance and then subsequently transmitted to the claims management data server device 50 along with an application code specific to the photographic device which captured the images. Examples of devices that may serve as the portable computing device 45 having photographic devices in them are provided in the description below.

Post the event, the user is required to take images of the vehicle in a manner required by the insurance companies to facilitate claims processing. The user utilizes a portable computing device 45 which has a photographic device to take the necessary images in the afore-mentioned required manner. As an example the required manner of images for claims processing can involve regions of vehicle covering the registration number, color, make and damaged sections of the vehicle in clarity for claims processing. Some examples of a portable computing device 45 having a photographic device are a mobile phone, a smartphone, personal digital assistant (PDA) or a tablet. The portable computing device 45 requires the user to install an application provided by the insurance company on the portable computing device 45 which provides the necessary guidance in taking the required images with the photographic device. The application that needs to be installed on the portable computing device 45 is obtained either through standard communication network 44 like the Internet, telecommunication lines or through a mobile application store from where it is downloaded. Every instance of the application installed on a portable computing device 45 of a user will have a unique application code assigned to it corresponding to that portable computing device 45, the user and the user data records at the insurance company.

The photographic device in the portable computing device 45 is used to take the required images with received guidance. As a part of the received guidance, an assistive stencil may be dynamically provided in the preview display to the user on the photographic device in the portable computing device 45. One example shows the assistive stencil is provided by the insurance company at the time of user registering with the insurance company and pre-installed on the photographic device in the portable computing device 45 by the user. Another example shows the user downloading the assistive stencil in real-time post the event, from the insurance company using standard communication network 44 like telecommunication lines or through the mobile application store. Examples of assistive stencil would be based on the image frames and one or more predefined vehicle photograph requirements. Here, the vehicle photograph requirements may correspond to certain conditions that have to be satisfied in order for the photograph to be acceptable for the purpose of claims processing by the insurance company post an event. The vehicle photograph requirements may be predefined by an authorizing authority. Examples of the vehicle photograph requirements can include but are not limited to the vehicle registration number, color and make of the vehicle and areas of damage on vehicle due to the event. The assistive stencil in the preview display of the photographic device in the portable computing device 45 guides the user in taking the right images in the required manner to satisfy the vehicle photograph requirements.

In some embodiments, the vehicle photograph requirements may be defined by the authorizing authority and provided on a server. A user may then download the requirements and save it locally on the photographic device in the portable computing device 45. The vehicle photograph requirements and the image frames of the vehicle may be used to identify and select one or more assistive stencils that are to be provided to the user in order to capture photographs that satisfy the requirements. Once the images are taken in the required manner by the photographic device in the portable computing device 45 with received guidance, they are then transmitted to the claims management data server device along with the unique application code using standard communication network 44 (incorporated by reference from U.S. patent application Ser. No. 14/068,516).

Referring back to FIG. 2a, after the images have been received by the claims management data server device along with the unique application code, a standard claims application will be created and filled up using user information retrieved from the claims management database server device based on one or more of those images and application code at step 110. To fill up the claims application, the claims management data server device first extracts user related data from one or more of the received images. This is done by passing at least one of the received images, which contains the vehicle registration number, through an Optical Character Reader (OCR) engine to recognize and obtain the vehicle registration number of the user. The retrieved vehicle registration number is then used in the claims management data server device to obtain the stored user insurance data that matches the vehicle registration number. Examples of stored user insurance data would include, but not limited to, user personal data, vehicle data, insurance policy data taken with the insurance company and prior historical claims data of the user for the registered vehicle. The standard claims application is then filled up to a maximum possible extent using the stored user insurance data that has been retrieved based on the one or more received images. Additionally, one or more of the received images containing the damaged sections of the vehicle is passed through a standard image analyzer software program to derive quantitative damage data and corresponding value for repair or replacement of damaged sections. The quantitative damage data and the value for repair or replacement parts are also used to fill up certain mandatory fields in the standard claims application. An example of filling up a standard claims application to a maximum possible extent would include filling user related data and damage data for at least the standard specified mandatory fields in the claims application, although other thresholds for indicating sufficient fields in the application are completed could be used.

Referring to FIGS. 2a and 2b, the details present in the filled up standard claims application is authenticated across multiple processes as described in steps 115, 120 and 125. The first level of authentication by the claims management data server device on the filled standard claims application is described in step 115 for verifying the user insurance data entered in the standard application form. The claims management data server device retrieves the user insurance data that corresponds to unique application code received from the portable computing device 45. The obtained user insurance data corresponding to the unique application code is then compared to the stored user insurance data that has been retrieved earlier based on the one or more received images and subsequently used to fill up the standard claims application. A match of the two retrieved user insurance data would then authenticate at first level the filled user insurance data in the standard claims application. If the match does not happen between the two sets of compared data, the claim is disapproved and the user is intimated of the same.

The next level of authentication of the filled user insurance data in the standard claims application is described in step 120 of FIG. 2a. The claims management data server device passes at least one or more of the received images from the portable computing device 45 through a standard image analyzer software program to obtain the color and make of the vehicle represented in the images. This retrieved color and make of the vehicle data from the images is then compared against the stored user insurance data that also has the vehicle color and make in the company insurance database. A match of the two records for the color and make of the vehicle would then authenticate at the second level the filled user insurance data in the standard claims application and that it is the same vehicle that is being claimed. This further helps in eliminating false claims for multiple vehicles. If the match does not happen between the two sets of compared data, the claim is disapproved and the user is intimated of the same.

The next level of authentication of the filled user insurance data in the standard claims application is described in step 125 of FIG. 2b. The claims management data server device retrieves the vehicle data that corresponds to the damaged sections due to the current event, from the one or more images received from the portable computing device 45. The obtained damaged sections data corresponding to the current event is then compared to the stored user insurance data that has the historical damage data for the vehicle from past events, and that which has been retrieved earlier based on the one or more received images. A match of the two retrieved damaged sections of the vehicle data would then authenticate at the third level the filled user insurance data in the standard claims application and that it is a new damage from a current event that is being claimed and not a false repeat claim for prior event damage. If the match does not happen between the two sets of compared data, the claim is disapproved and the user is intimated of the same.

Referring back to FIG. 2b, the next step involves calculation of the claims amount by the claims management data server device based on data in the filled claims application form, which is described in step 130. The claims amount is calculated as per typical standard methods for claims calculation based on the filled up data in the claims application form which includes but not limited to the quantitative damage data of the vehicle in the event, cost value for repair, cost value for replacement of necessary parts, all of which have been derived from analyzing one or more of the received images containing the damaged sections of the vehicle post an event, and cost value for associated skilled labor for carrying out the repair and/or replacement.

The next step 135 in FIG. 2b involves the claims management data server device obtaining the stored claim limit specific to the user from the stored user insurance data. The stored claim limit specific to the user can be based on but not restricted to, a few parameters like user claim history, user insurance policy details, and total monetary value of claims. The stored claim limit specific to the user is then compared to the calculated claims amount from step 130 to verify if the calculated claims amount is lower than the stored claim limit for the user. In the event of the calculated claims amount is lower than the stored claims limit for the user, then the claims amount is automatically approved by the claims management data server device 50 and an intimation of the decision is sent back immediately to the user as described in step 140. Intimation of the user of the claims application being approved can be done through typical means of communication network 44 which may include as an example but not limited to only Short Message Service (SMS), direct phone call, and mobile applicative chat software. Intimation of the user of the claims application being approved can also be done through the Internet which include as an example but not limited to, emails or alert messages. In the event of the calculated claims amount is higher than the stored claims limit for the user, then the calculated claims amount is not automatically approved by the claims management data server device 50 and a manual survey and estimation of damage by an independent claims estimator is recommended by the claims management data server device 50 for continuation of the claims processing.

The specification has described a method and device for improving claims processing for a vehicle in an event. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more non-transitory computer-readable storage media may be utilized in implementing embodiments consistent with the present disclosure. A non-transitory computer-readable storage medium refers to any type of physical memory on which information or data readable by a processor may be stored. Thus, a non-transitory computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. A method for improving claims processing for a vehicle in an event, the method comprising:
receiving, at a claims management data server device, an application code and one or more images of the vehicle captured by a photographic device in a portable computing device based on received guidance;
filling, at the claims management data server device, a claims application for a user based on the application code and the one or more images;
authenticating the claims application at the claims management data server device;
calculating, at the claims management data server device, a claim amount based on the authenticated claims application;
determining whether the calculated claim amount is approved for the claims application, at the claims management data server device, based on a stored claim limit associated with the user; and
providing, by the claims management data server device, an indication on the determination of whether the calculated claim amount is approved.

2. The method of claim 1, wherein the filling further comprises of:
retrieving, by the claims management data server device, stored user insurance data corresponding to the one or more received images; and
automatically filling up the claims application, with the claims management data server device, based on the retrieved user insurance data.

3. The method of claim 2, wherein the authenticating further comprises:
obtaining, with the claims management data server device, new stored user insurance data corresponding to the received application code;
comparing, with the claims management data server device, the obtained new stored user insurance data corresponding to the received application code against the retrieved stored user insurance data corresponding to the received one or more images; and
authenticating, with the claims management data server device, the claims application at least partially when the comparing indicates the obtained new stored user insurance data matches the retrieved stored user insurance data.

4. The method of claim 3, wherein the authenticating further comprises:
obtaining, with the claims management data server device, color and make of the vehicle based on the one or more received images;
comparing, with the claims management data server device, the obtained color and make of the vehicle against the retrieved stored user insurance data; and
authenticating, with the claims management data server device, the claims application further when the comparing indicates the obtained color and make of the vehicle matches a retrieved color and make in the retrieved stored user insurance data.

5. The method of claim 3, wherein the authenticating further comprises:
obtaining, with the claims management server device, historical data on prior damage to the vehicle;
comparing the obtained historical data on the prior damage to the vehicle against the one or more received images to verify new damage to the vehicle; and
authenticating, with the claims management data server device, the claims application further when the comparing verifies the new damage to the vehicle.

6. The method of claim 1, wherein the determining further comprises:
obtaining, with the claims management data server device, the stored claim limit associated with the user;
comparing, with the claims management server device, the calculated claim amount against the obtained stored claim limit; and
determining, with the claims management data server device, whether the calculated claims amount is below the obtained stored claim limit

7. The method of claim 1, wherein the portable computing device providing the one or more received images comprises at least one of a mobile phone, a personal digital assistant, a digital camera with network communication capability or a tablet.

8. The method of claim 1, wherein the one or more received images comprises at least a vehicle registration number, sections of the vehicle providing color, make and damage of the vehicle due to the event.

9. A claims management data server device, comprising:
a memory; and
a processor coupled to the memory and configured to execute programmed instructions stored in the memory, comprising:
receiving an application code and one or more images of the vehicle captured by a photographic device in a portable computing device based on received guidance;
filling a claims application for a user based on the application code and the one or more images;
authenticating the claims application;
calculating a claim amount based on the authenticated claims application;
determining whether the calculated claim amount is approved for the claims application, based on a stored claim limit associated with the user; and
providing an indication on the determination of whether the calculated claim amount is approved.

10. The device of claim 9, wherein the processor is further configured to execute programmed instructions stored in the memory for the filling, further comprises:
retrieving stored user insurance data corresponding to the one or more received images; and
automatically filling up the claims application based on the retrieved user insurance data.

11. The device of claim 10, wherein the processor is further configured to execute programmed instructions stored in the memory for the authenticating further comprises:
obtaining new stored user insurance data corresponding to the received application code;
comparing the obtained new stored user insurance data corresponding to the received application code against the retrieved stored user insurance data corresponding to the received one or more images; and
authenticating the claims application at least partially when the comparing indicates the obtained new stored user insurance data matches the retrieved stored user insurance data.

12. The device of claim 11, wherein the processor is further configured to execute programmed instructions stored in the memory for the authenticating further comprises:
obtaining color and make of the vehicle based on the one or more received images;
comparing the obtained color and make of the vehicle against the retrieved stored user insurance data; and
authenticating the claims application further when the comparing indicates the obtained color and make of the vehicle matches a retrieved color and make in the retrieved stored user insurance data.

13. The device of claim 11, wherein the processor is further configured to execute programmed instructions stored in the memory for the authenticating further comprises:
obtaining historical data on prior damage to the vehicle;
comparing the obtained historical data on the prior damage to the vehicle against the one or more received images to verify new damage to the vehicle; and
authenticating the claims application further when the comparing verifies the new damage to the vehicle.

14. The device of claim 9, wherein the processor is further configured to execute programmed instructions stored in the memory for the determining further comprises:
obtaining the stored claim limit associated with the user;
comparing the calculated claim amount against the obtained stored claim limit; and
determining whether the calculated claims amount is below the obtained stored claim limit

15. The device of claim 9, wherein the portable computing device providing the one or more received images, comprises at least one of a mobile phone, a personal digital assistant, a digital camera with network communication capability or a tablet.

16. The device of claim 9, wherein the one or more received images, provided by the photographic device, comprises at least a vehicle registration number, sections of the vehicle providing color, make and damage of the vehicle due to the event.

17. A non-transitory computer readable medium having stored thereon instructions for improving claims processing for a vehicle in an event comprising machine executable code which when executed by a processor, causes the processor to perform steps comprising:
receiving an application code and one or more images of the vehicle captured by a photographic device in a portable computing device based on received guidance;
filling a claims application for a user based on the application code and the one or more images;
authenticating the claims application;
calculating a claim amount based on the authenticated claims application;
determining whether the calculated claim amount is approved for the claims application, based on a stored claim limit associated with the user; and
providing an indication on the determination of whether the calculated claim amount is approved.

18. The medium of claim 17, wherein the filling further comprises:
retrieving stored user insurance data corresponding to the one or more received images; and
automatically filling up the claims application based on the retrieved user insurance data.

19. The medium of claim 18, wherein the authenticating further comprises:
obtaining new stored user insurance data corresponding to the received application code;
comparing the obtained new stored user insurance data corresponding to the received application code against the retrieved stored user insurance data corresponding to the received one or more images; and
authenticating the claims application at least partially when the comparing indicates the obtained new stored user insurance data matches the retrieved stored user insurance data.

20. The medium of claim 19, wherein the authenticating further comprises:
obtaining color and make of the vehicle based on the one or more received images;
comparing the obtained color and make of the vehicle against the retrieved stored user insurance data; and
authenticating the claims application further when the comparing indicates the obtained color and make of the vehicle matches a retrieved color and make in the retrieved stored user insurance data.

21. The medium of claim 19, wherein the authenticating further comprises:
obtaining historical data on prior damage to the vehicle;
comparing the obtained historical data on the prior damage to the vehicle against the one or more received images to verify new damage to the vehicle; and
authenticating the claims application further when the comparing verifies the new damage to the vehicle.

22. The medium of claim 17, wherein the determining further comprises:
obtaining the stored claim limit associated with the user;
comparing the calculated claim amount against the obtained stored claim limit; and
determining whether the calculated claims amount is below the obtained stored claim limit

23. The medium of claim 17, wherein the portable computing device providing the one or more received images, comprises at least one of a mobile phone, a personal digital assistant, a digital camera with network communication capability or a tablet.

24. The medium of claim 17, wherein the one or more received images, provided by the photographic device, comprises at least a vehicle registration number, sections of the vehicle providing color, make and damage of the vehicle due to the event.
